(19) United States
(12) Patent Application Publication
(10) Pub. No.: US 2007/0177601 A1
(43) Pub. Date: Aug. 2, 2007

(54) Cell assembling method and device

(76) Inventors: Katsuya Tsushita, Kawasaki (JP); Yasuhiro Ooba, Kawasaki (JP); Akio Yokotsuka, Kawasaki (JP)

Correspondence Address: KATTEN MUCHIN ROSENMAN LLP, 575 MADISON AVENUE, NEW YORK, NY, 10022-2585, US

(21) Appl. No.: 11/444,217

(22) Filed: May 31, 2006

(30) Foreign Application Priority Data
Jan. 31, 2006 (JP) 2006-022708

(51) Int. Cl. H04L 12/56

(52) U.S. Cl. 370/395.1

(57) ABSTRACT

In a cell assembling method and device for packets received from a plurality of input ports, packets received from e.g. four input ports are respectively stored in packet buffers. By sequentially and cyclically providing a read request to the packet buffers at regular intervals, the packets per fixed length data are sequentially and cyclically read. Then, by capsulating the fixed length data read (any one of fixed length data), the data is converted into e.g. an ATM cell. Alternatively, based on cell assembling information (any one of cell assembling information synchronized with fixed length data), e.g. an ATM header is generated to be used for a conversion into the ATM cell.

### BACKGROUND OF THE INVENTION

1. Field of the Invention

The present invention relates to a cell assembling (cellularization) method and device, and in particular to a cell assembling method and device converting packets received from a plurality of input ports into cells.

2. Description of the Related Art

Recently, networks using Ethernet (registered trademark) and IP (Internet Protocol)(hereinafter, occasionally simply referred to as IP networks) have been increasingly constructed, and accordingly various technologies for mutual connection with an ATM network using an ATM (Asynchronous Transfer Mode) that is a prior art data communication system have been proposed (see e.g. patent document 1).

In such a mutual connection between the IP network and the ATM network, a conversion (hereinafter, occasionally referred to as cell assembling) is performed from a packet or a frame (hereinafter, generically referred to as packet) that is a transmission data unit of the IP network to an ATM cell (hereinafter, occasionally simply referred to as cell) that is a transmission data unit of the ATM network.

Hereinafter, prior art examples [1] and [2] of the cell assembling will be described.

### Prior Art Example [1]: FIG. 10

A cell assembling device shown in FIG. 10 is composed of four input ports 100_1-100_4 (hereinafter, occasionally represented by a reference numeral 100), packet buffers 200_1-200_4 (hereinafter, occasionally represented by a reference numeral 200) provided corresponding to each of the ports 100_1-100_4, cell assembling processors 400_1-400_4 (hereinafter, occasionally represented by a reference numeral 400) connected to each of the packet buffers 200_1-200_4, cell buffers 600_1-600_4 (hereinafter, occasionally represented by a reference numeral 600) provided corresponding to each of the cell assembling processors 400_1-400_4, and a single common selector 700 connected to each of the cell assembling processors 400_1-400_4.

This cell assembling device, as shown in FIG. 10, stores a packet PCKT_1 (hereinafter, occasionally represented by a reference character PCKT) received from e.g. the port 100_1 in the packet buffer 200_1 (see (a) in FIG. 10). The cell assembling processor 400_1 reads the stored packet PCKT_1 from the packet buffer 200_1 (see (b) in FIG. 10), converts the stored packet into an ATM cell CL, and stores the converted ATM cell CL in the cell buffer 600_1 (see (c) in FIG. 10).

In the same way as the above, the packets PCKT_2-PCKT_4 received from the ports 100_2-100_4 are respectively once stored in the packet buffers 200_2-200_4. Then, the cell assembling processors 400_2-400_4 respectively convert the packets into the ATM cells CL to be stored in the cell buffers 600_2-600_4.

The selector 700 sequentially provides a read request per cell to the cell buffers 600_1-600_4 in the order of e.g. the cell buffer 600_1→600_2→600_3→600_4 (see (d) in FIG. 10), thereby reading therefrom the ATM cells CL (see (e) in FIG. 10) to be transmitted to an ATM network (not shown) at the subsequent stage.

Thus, it is made possible to independently perform cell assembling to the packets PCKT_1-PCKT_4 received from the ports 100_1-100_4.

### Prior Art Example [2]: FIG. 11

The cell assembling device shown in FIG. 11 is composed of the four input ports 100_1-100_4, the packet buffers 200_1-200_4 provided corresponding to each of the ports 100_1-100_4, a single common read controller 800 connected to the packet buffers 200, and the cell assembling processor 400 connected to the read controller 800. This cell assembling device is not provided with the individual cell assembling processors 400_1-400_4 and the cell buffers 600_1-600_4 corresponding to the ports 100_1-100_4, different from the above-mentioned prior art example [1].

This cell assembling device, as shown in FIG. 11, stores (see (a) in FIG. 11) the packets PCKT_1-PCKT_4 received from the ports 100_1-100_4 in the same way as the above-mentioned prior art example [1] respectively in the packet buffers 200_1-200_4.

The read controller 800 monitors the reception timing and the data amount of a packet per port 100_1-100_4 (e.g. a packet flow volume read from the packet buffers 200_1-200_4) so that cell assembling is equally performed to the stored packets PCKT_1-PCKT_4, selects the packet buffer 200 in such an order that each packet flow volume is equalized (e.g. in the ascending order of the packet flow volume), and provides the read request (see (b) in FIG. 11). Thus, the read controller 800 reads the packet PCKT from the selected packet buffer 200 (see (c) in FIG. 11), and provides the packet PCKT read, i.e. a selected packet (d) shown in FIG. 11 to the cell assembling processor 400.

The cell assembling processor 400 having received the packet converts the selected packet (d) into the ATM cell CL to be transmitted to the ATM network (not shown) at the subsequent stage.

Thus, it is made possible to equally perform the cell assembling to the packets PCKT_1-PCKT_4 received from the ports 100_1-100_4 without using the individual cell assembling processor and cell buffer.
[Patent document 1] Japanese Patent Application Laid-open No. 11-88336

As for the above-mentioned prior art example [1], there has been a problem that the cell assembling processor and the cell buffer have to be provided per input port, and that the circuit scale of an entire cell assembling device becomes large.

Also, as for the above-mentioned prior art example [2], while the cell assembling processor and the cell buffer are not required per input port, a complicated packet flow volume monitoring control and an adjustment control of the read request timing are required in the read controller in order to equally perform the cell assembling to the packets received from the input ports since the reception timing and the data amount of the packet from the input ports are random. Accordingly, there has been a problem that a cell assembling is delayed due to the controls.

### SUMMARY OF THE INVENTION

It is accordingly an object of the present invention to provide a cell assembling method and device for packets received from a plurality of input ports, which can reduce a circuit scale, simplify a control, and execute the cell assembling.

In order to achieve the above-mentioned object, a cell assembling method (or device) according to one aspect of the present invention comprises: a first step of (or means) storing packets received from a plurality of input ports in buffers provided corresponding to the input ports; a second step of (or means) reading the packets per fixed length data from the buffers by sequentially providing a read request to the buffers; and a third step of (or means) converting the fixed length data into cells.

Also, in the above-mentioned aspect, the second step (or means) may comprise a step of (or means) sequentially and cyclically reading the packets per fixed length data from the buffers with sequentially and cyclically providing the read request to the buffers at regular intervals.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an operation principle of a cell assembling method and device according to the present invention;

FIG. 2 is a block diagram showing an embodiment [1] of a cell assembling method and device according to the present invention;

FIG. 3 is a time chart showing an entire operation of an embodiment [1] in a cell assembling method and device according to the present invention;

FIG. 4 is a block diagram showing a cell assembling example of an embodiment [1] in a cell assembling method and device according to the present invention;

FIGS. 5A-5C are diagrams showing a format example of a conversion from a packet to a cell used for a cell assembling method and device according to the present invention;

FIG. 6 is a block diagram showing an arrangement of an embodiment [2] and its operation example in a cell assembling method and device according to the present invention;

FIG. 7 is a block diagram showing an arrangement of an embodiment [3] and its operation example (cell assembling example (1)) in a cell assembling method and device according to the present invention;

FIG. 8 is a block diagram showing an arrangement of an embodiment [3] and its operation example (cell assembling example (2)) in a cell assembling method and device according to the present invention;

FIG. 9 is a block diagram showing an arrangement of an embodiment [3] and its operation example (cell assembling example (3)) in a cell assembling method and device according to the present invention;

FIG. 10 is a block diagram showing a prior art example [1] of cell assembling; and

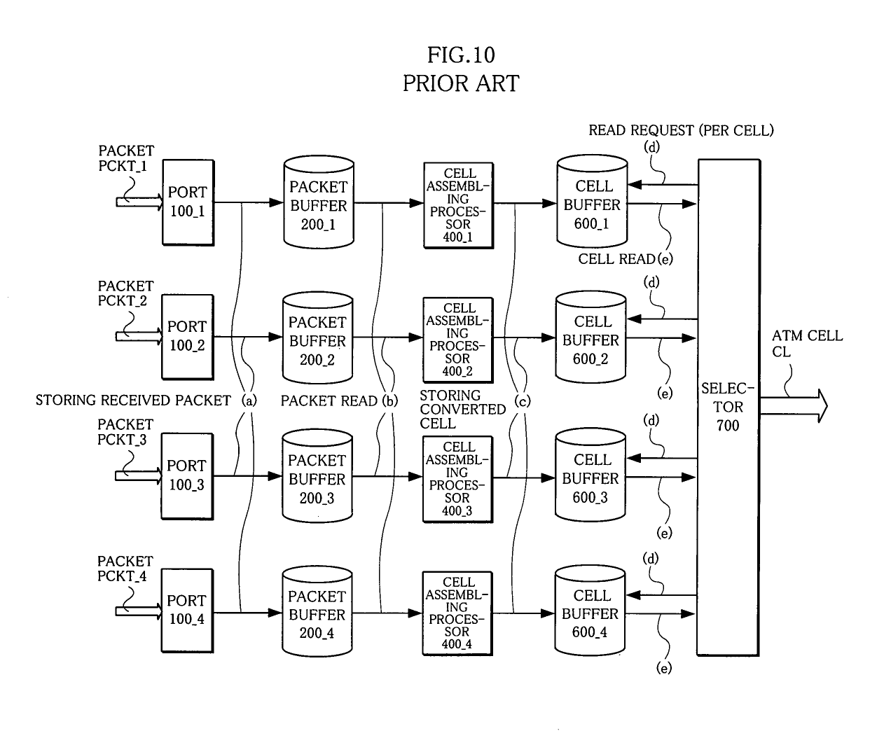

FIG. 11 is a block diagram showing a prior art example [2] of cell assembling.

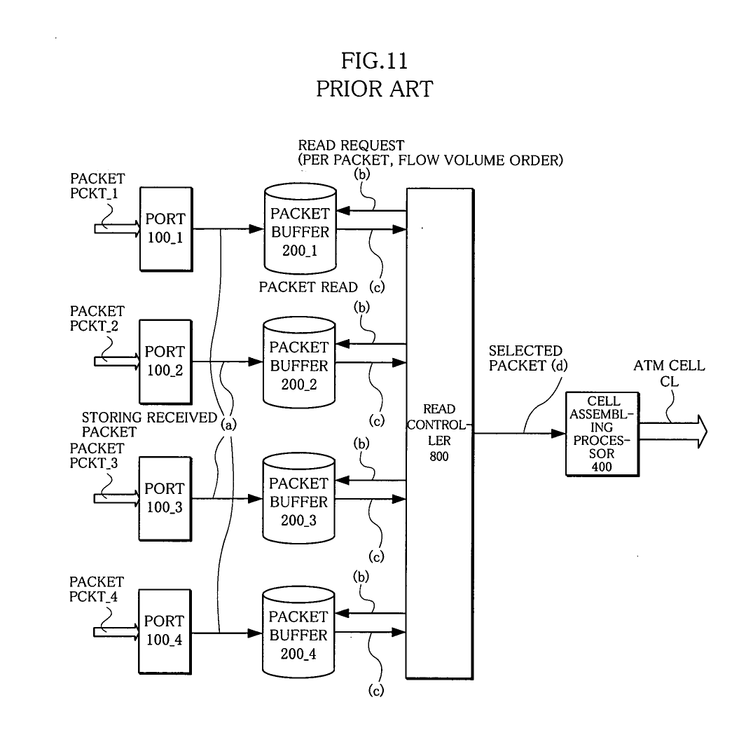

### DESCRIPTION OF THE PREFERRED EMBODIMENTS

[1] In order to achieve the above-mentioned object, a cell assembling method (or device) according to one aspect of the present invention comprises: a first step of (or means) storing packets received from a plurality of input ports in buffers provided corresponding to the input ports; a second step of (or means) reading the packets per fixed length data from the buffers by sequentially providing a read request to the buffers; and a third step of (or means) converting the fixed length data into cells.
[2] Also, in the above-mentioned [1], the second step (or means) may comprise a step of (or means) sequentially and cyclically reading the packets per fixed length data from the buffers with sequentially and cyclically providing the read request to the buffers at regular intervals.

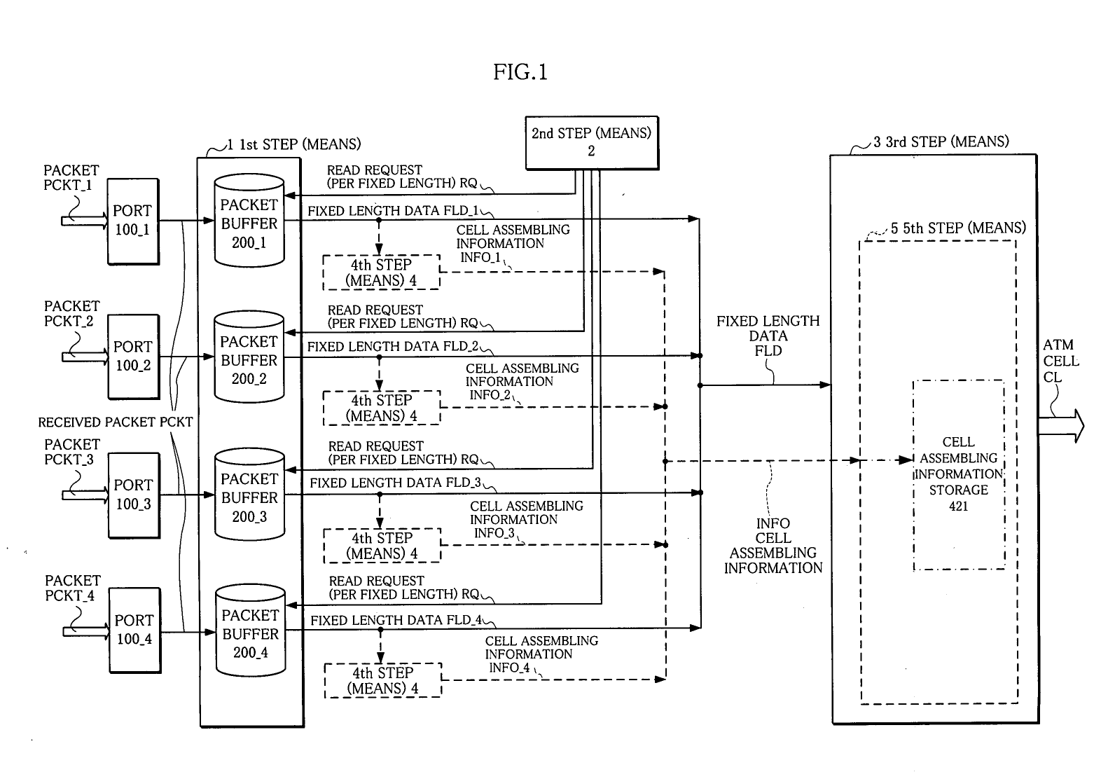

The cell assembling method (or device) according to the aspect of the present invention will now be described referring to an operation principle shown by solid lines in FIG. 1, to which the present invention is not limited.

At the first step (or means) 1, e.g. packets PCKT_1-PCKT_4 respectively received from four input ports 100_1-100_4 are stored in packet buffers 200_1-200_4 respectively corresponding to the ports 100_1-100_4.

At the second step (or means) 2, a read request RQ is repeatedly, sequentially, and cyclically provided to the packet buffers 200_1-200_4 at regular intervals in an order of e.g. packet buffer 200_1→200_2→200_3→200_4. The packets PCKT_1-PCKT_4 are cyclically read from the packet buffers 200_1-200_4 per fixed length data. Namely, when e.g. the packet is converted into an ATM cell, the packet is cyclically read as fixed length data FLD_1-FLD_4 (hereinafter, occasionally represented by a reference character FLD) divided per ATM payload length (48 bytes), and the fixed length data FLD is provided to the third step (or means) 3.

Supposing that e.g. the second step (or means) 2 provides the read request RQ to the packet buffer 200_1, the second step (or means) 2 reads the fixed length data FLD_1 to be provided to the third step (or means) 3.

When any one of the fixed length data FLD_1-FLD_4 is received, the third step (or means) 3 capsulates the fixed length data FLD. For example, the third step (or means) 3 extracts necessary information from the fixed length data FLD, generates an ATM header, and adds the ATM header to the fixed length data FLD to be converted into an ATM cell CL.

Thus, in the cell assembling method (or device) by the aspect of the present invention, it is possible to perform the cell assembling to the packets received from a plurality of input ports without providing the cell assembling processors and cell buffers for individual input ports. Namely, it is possible to perform the cell assembling by reducing a circuit scale. Also, it is possible to perform a control without depending on the reception timing and the data amount of the packet from the input ports. Namely, it is possible to simplify the control. Therefore, the cell assembling can be performed speedily without delay.
[3] Also, in the above-mentioned [1] or [2], the first step (or means) may comprise a step of (or means) capsulating the received packets to an upper layer and of storing the capsulated packets in the buffers.

Namely, when the received packet PCKT is required to be capsulated in a format of an upper layer such as AAL5, for example, at the first step (or means) 1, inter-layer adjustment information such as AAL5 header information and AAL5 trailer information is added to the received packet PCKT to be capsulated before the received packet PCKT is stored in the packet buffer 200.

In the same way as the above-mentioned [1] or [2], the second step (or means) 2 cyclically provides the read request RQ to the packet buffers 200_1-200_4 at regular intervals, cyclically reads the capsulated data from the packet buffers 200_1-200_4 as the fixed length data FLD_1-FLD_4 at regular intervals, and provides the fixed length data FLD to the third step (or means) 3, so that the third step (or means) 3 having received the fixed length data converts the data into the ATM cell CL.

Thus, the aspect of the present invention can be easily applied to the case where the packet is required to be capsulated in a format of the upper layer.
[4] Also, in the above-mentioned [1] or [2], the cell assembling method (or device) may further comprise a fourth step of (or means) generating cell assembling information necessary for converting the fixed length data read at the second step (or means) into the cells, and a fifth step of (or means) generating header information of the cells based on the cell assembling information and of using the header information for the conversion at the third step (or means).

Namely, as shown by the dotted lines in FIG. 1, at the fourth step (or means) 4, cell assembling information INFO_1-INFO_4 (hereinafter, occasionally represented by a reference character INFO) necessary for generating an ATM header or the like shown by e.g. the above-mentioned [1] or [2] is generated respectively from the fixed length data FLD_1-FLD_4 every time the fixed length data FLD_1-FLD_4 is read at the second step (or means) 2, and the cell assembling information INFO is provided to the fifth step (or means) 5.

Supposing that the read request RQ is provided to e.g. the packet buffer 200_1 in the same way as the above-mentioned [1] or [2], the cell assembling information INFO_1 is provided to the fifth step (or means) 5.

When any one of the cell assembling information INFO_1-INFO_4 is received, header information of cells, e.g. the ATM header is generated based on the cell assembling information INFO at the fifth step (or means) 5 to be provided to the third step (or means) 3 (this operation is not shown).

In this case, at the third step (or means) 3, it becomes unnecessary to extract information necessary for the generation of the ATM header from the fixed length data FLD as shown in the above-mentioned [1] or [2] and to generate the ATM header. Therefore, it is possible to shorten a processing time concerning the conversion to the ATM cell CL. Together with this, it is possible to shorten the interval of the read requests RQ provided to the packet buffers 200_1-200_4 at the second step (or means) 2. Therefore, the throughput of the entire cell assembling can be improved.

It is to be noted that while FIG. 1 shows that the fourth step (or means) 4 is provided corresponding to each of the packet buffers 200_1-200_4, and the fifth step (or means) 5 is included in the third step (or means) 3, the aspect of the present invention is not limited to this. For example, it is possible that e.g. a single fourth step (or means) 4 is connected to the packet buffers 200_1-200_4 with a common bus or the like, and the fifth step (or means) 5 is provided outside the third step (or means) 3.
[5] Also, in the above-mentioned [4], the cell assembling information may include an identifier of the input ports, header information of the received packets, and an identifier indicating fixed length data of a start or an end of the received packets.

Namely, the cell assembling information INFO can include e.g. identifiers of the input ports 100_1-100_4, header information of the received packets PCKT, an identifier indicating fixed length data FLD of a start or end of the received packets PCKT, i.e. an SOP (Start Of Packet) or EOP (End Of Packet) for example.
[6] Also, in the above-mentioned [5], only when detecting the fixed length data of the start of the received packets, the fourth step (or means) may comprise a step of (or means) setting the header information of the received packets in the cell assembling information.

In this case, it is possible not to set the header information of the received packets PCKT in the cell assembling information INFO unless the fourth step (or means) 4 detects the SOP (i.e. upon SOP non-detection). Therefore, it is possible to reduce a flow volume of the cell assembling information INFO, and to further reduce a processing load of the entire cell assembling.

It is to be noted that the above-mentioned SOP non-detection time includes the case where data to be read does not exist in the packet buffer 200.
[7] Also, a cell assembling method (or device) according to one aspect of the present invention comprises: a first step of (or means) storing packets received from a plurality of input ports in buffers provided corresponding to the input ports; a second step of (or means) dividing the packets from the buffers into data of a start, an end, and an intermediate portion to be sequentially read; and a third step of (or means) adding to the divided data inter-layer adjustment information necessary for capsulation to an upper layer, corresponding to a size of the divided data read at the second step (or means) and of converting the divided data into cells.
[8] Also, in the above-mentioned [7], the second step (or means) may comprise a step of (or means) dividing the packets from the buffers into the data of the start, the end, and the intermediate portion to be sequentially and cyclically read.

Namely, at the second step (or means) 2, the read request RQ is cyclically provided to the packet buffers 200_1-200_4 at regular intervals in the same way as the above-mentioned [3]. However different from the above-mentioned [3], an addition size of inter-layer adjustment information necessary for capsulation to an upper layer is preliminarily considered, and the packets PCKT_1-PCKT_4 are divided into the respective data of the start, the end, and the intermediate portion to be cyclically read from the packet buffers 200_1-200_4.

For example, the second step (or means) 2 divides the packet PCKT into data of a length considering the size of the AAL5 header information added to the start of the packet PCKT, data of a length considering the size of the AAL5 trailer information added to the end of the packet PCKT, and data of a length of the intermediate portion not requiring the addition of information to be cyclically read. The divided data DATA_1-DATA_4 (not shown)(hereinafter, occasionally represented by a reference character DATA) is provided to the third step (or means) 3.

When receiving the divided data DATA, the third step (or means) 3 properly adds the necessary inter-layer adjustment information to the divided data DATA to be converted into the ATM cell CL, corresponding to the size of the divided data DATA, namely by determining from the data length to which of the data of start, the end, and the intermediate portion the divided data DATA corresponds.

Thus, the second step (or means) 2 preliminarily considers the addition size of the inter-layer adjustment information, and reads the data from the packet buffer 200, thereby enabling a single processor (the third step (or means) 3) to perform capsulation to a format of the upper layer.
[9] Also, in the above-mentioned [7] or [8], the cell assembling method (or device) may further comprise a fourth step of (or means) generating cell assembling information necessary for converting the divided data read at the second step (or means) into the cells, and a fifth step of (or means) generating header information of the cells based on the cell assembling information and of using the header information for the conversion at the third step (or means).

Namely, in the same way as the above-mentioned [4], at the fourth step (or means) 4, the cell assembling information INFO_1-INFO_4 is generated respectively from the divided data DATA_1-DATA_4 every time the divided data DATA_1-DATA_4 is read at the second step (or means) 2, and the cell assembling information INFO is provided to the fifth step (or means) 5.

When any one of the cell assembling information INFO_1-INFO_4 is received, the header information of the cell, i.e. the ATM header for example is generated based on the cell assembling information INFO at the fifth step (or means) 5 to be provided to the third step (or means) 3.

Also in this case, in the same way as the above-mentioned [4], it becomes unnecessary to extract information necessary for the ATM header generation from the divided data DATA and to generate the ATM header. Therefore, it is possible to shorten the processing time concerning the conversion to the ATM cell CL.
[10] Also, in the above-mentioned [9], the cell assembling information may include an identifier of the input ports, header information of the received packets, and an identifier indicating the divided data of the start or the end of the received packets.

Namely, in the same way as the above-mentioned [5], the cell assembling information INFO can include an identifier of the input ports 100_1-100_4, header information of the received packets PCKT, an identifier (SOP or EOP) indicating the divided data DATA of the start or the end of the received packets PCKT.
[11] Also, in the above-mentioned [10], only when detecting the divided data of the start of the received packets, the fourth step (or means) may comprise a step of (or means) setting the header information of the received packets in the cell assembling information.

Also in this case, like the above-mentioned [6], it is possible not to set the header information of the received packets PCKT in the cell assembling information INFO unless the fourth step (or means) 4 detects the SOP.
[12] Also, in the above-mentioned [4] or [9], the fifth step (or means) may comprise a step of (or means) storing the cell assembling information to be used for conversions to subsequent cells.

Namely, a cell assembling information storage 421 provided within the fifth step (or means) 5 indicated by long and short dashed lines of FIG. 1 e.g. stores the cell assembling information INFO when the fixed length data of the start of the packet PCKT is read, generates the ATM header based on the cell assembling information INFO until the fixed length data of the end of the packet PCKT is received, and provides the ATM header to the third step (or means) 3.

In this case, it becomes unnecessary to generate the cell assembling information INFO_1-INFO_4 every time the fixed length data FLD_1-FLD_4 shown in the above-mentioned [4] is read at the fourth step (or means) 4. Therefore, the processing load of the entire cell assembling can be reduced.

According to the aspect of the present invention, in the cell assembling for the packets received from a plurality of input ports, a cell assembling processor and a cell buffer per input port are not required, controls not depending on the reception timing and the data amount of the packet from the input ports can be performed, thereby enabling the circuit scale to be reduced, the controls to be simplified, and the cell assembling to be speedily performed without delay.

Furthermore, the received packet is capsulated to the upper layer to be stored in the packet buffer, or data is read from the packet buffer preliminarily considering the addition size of the inter-layer adjustment information necessary for the capsulation to the upper layer. Therefore, the cell assembling corresponding to the capsulation to the upper layer can be easily performed.

Also, it is made possible to generate the cell assembling information necessary for the conversion to the cells and to use the information. Therefore, it is possible to improve the throughput of the entire cell assembling and to reduce the processing load.

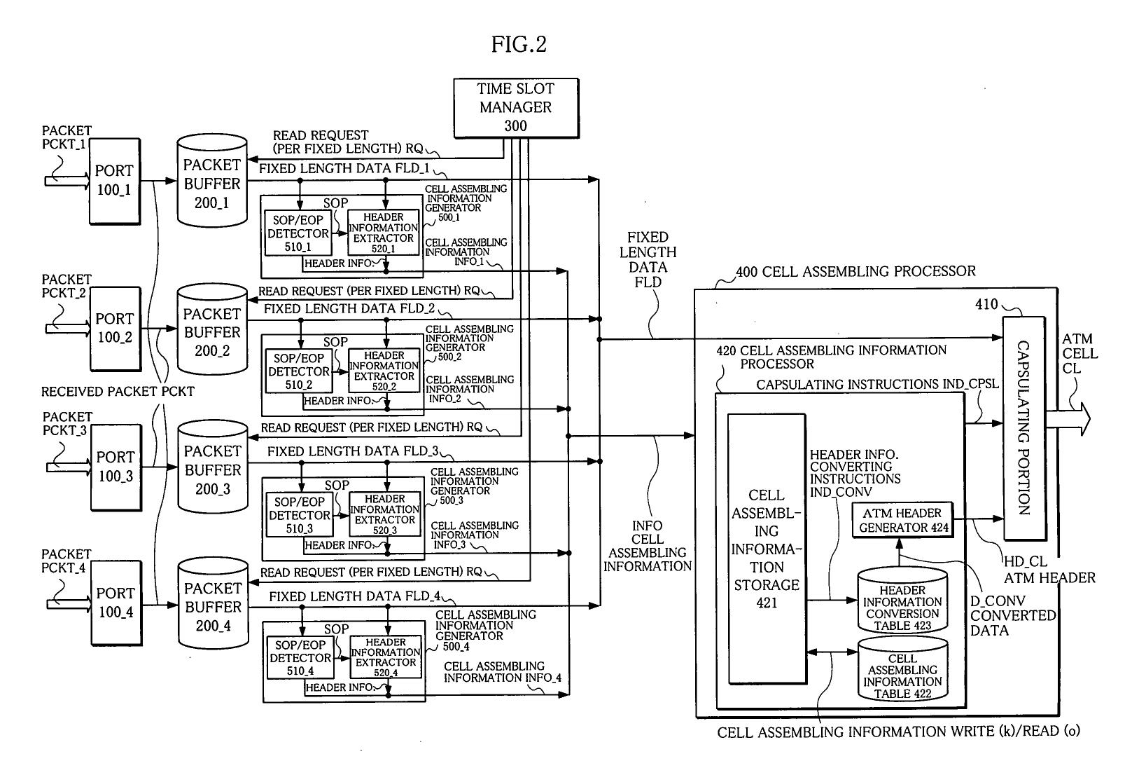

Embodiments [1]-[3] of the cell assembling method and device using the same according to the present invention whose principle is shown in FIG. 1 will now be described referring to FIGS. 2, 3, 4, 5A, 5B, 5C, 6, 7, 8, and 9.

### Embodiment [1]: FIGS. 2, 3, 4, 5A, 5B, and 5C

### [1]-1 Arrangement: FIG. 2

In the same way as FIG. 1, the cell assembling device shown in FIG. 2 is provided with the four input ports 100_1-100_4, the packet buffers 200_1-200_4 storing the packets PCKT_1-PCKT_4 respectively received from the ports 100_1-100_4, a common time slot manager 300 cyclically providing a read request RQ per fixed length data at regular intervals to the packet buffers 200_1-200_4 and reading the fixed length data FLD_1-FLD_4 respectively from the packet buffers 200_1-200_4, a cell assembling processor 400 receiving the fixed length data FLD, indicating any one of fixed length data FLD_1-FLD_4, to be converted (cell assembling) into the ATM cell CL, and cell assembling information generators 500_1-500_4 (hereinafter, occasionally represented by a reference numeral 500) generating the cell assembling information INFO_1-INFO_4 respectively from the fixed length data FLD_1-FLD_4 read from the packet buffers 200_1-200_4 and providing the cell assembling information INFO_1-INFO_4 to the cell assembling processor 400 to be used for the cell assembling.

The cell assembling processor 400 is further provided with a cell assembling information processor 420 generating an ATM header HD_CL based on the cell assembling information INFO, and a capsulating portion 410 capsulating the ATM header HD_CL generated and the fixed length data FLD. Also, the cell assembling information processor 420 is provided with a cell assembling information storage 421, a cell assembling information table 422, a header information conversion table 423, and an ATM header generator 424.

Also, the cell assembling information generators 500_1-500_4 are provided with SOP/EOP detectors 510_1-510_4 (hereinafter, occasionally represented by a reference numeral 510) and header information extractors 520_1-520_4 (hereinafter, occasionally represented by a reference numeral 520).

It is to be noted that while the first step (or means) 1-the fifth step (or means) 5 shown in FIG. 1 respectively correspond to packet buffers 200_1-200_4, the time slot manager 300, the cell assembling processor 400, the cell assembling information generators 500_1-500_4, and the cell assembling information processor 420, these steps or means are not limited to these portions.

### [1]-2 Embodiment of Operation: FIGS. 2, 3, 4, 5A, 5B, and 5C

The operation of this embodiment [1] will now be described referring to FIGS. 2, 3, 4, 5A, 5B, and 5C. It is to be noted that since various cell assembling methods can be conceived, these methods are not specifically limited to the following operation example.

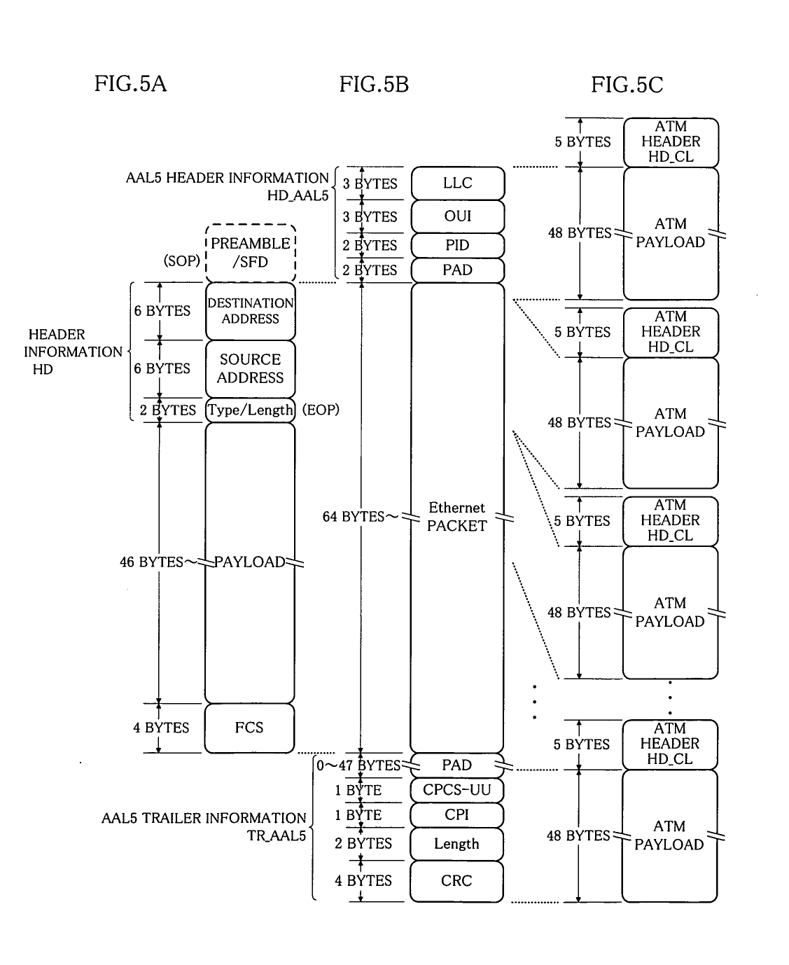

It is to be noted that in this embodiment a PDU (Protocol Data Unit) format of an AAL5 shown in FIG. 5B is not used when an Ethernet packet of FIG. 5A is converted into an ATM cell of FIG. 5C.

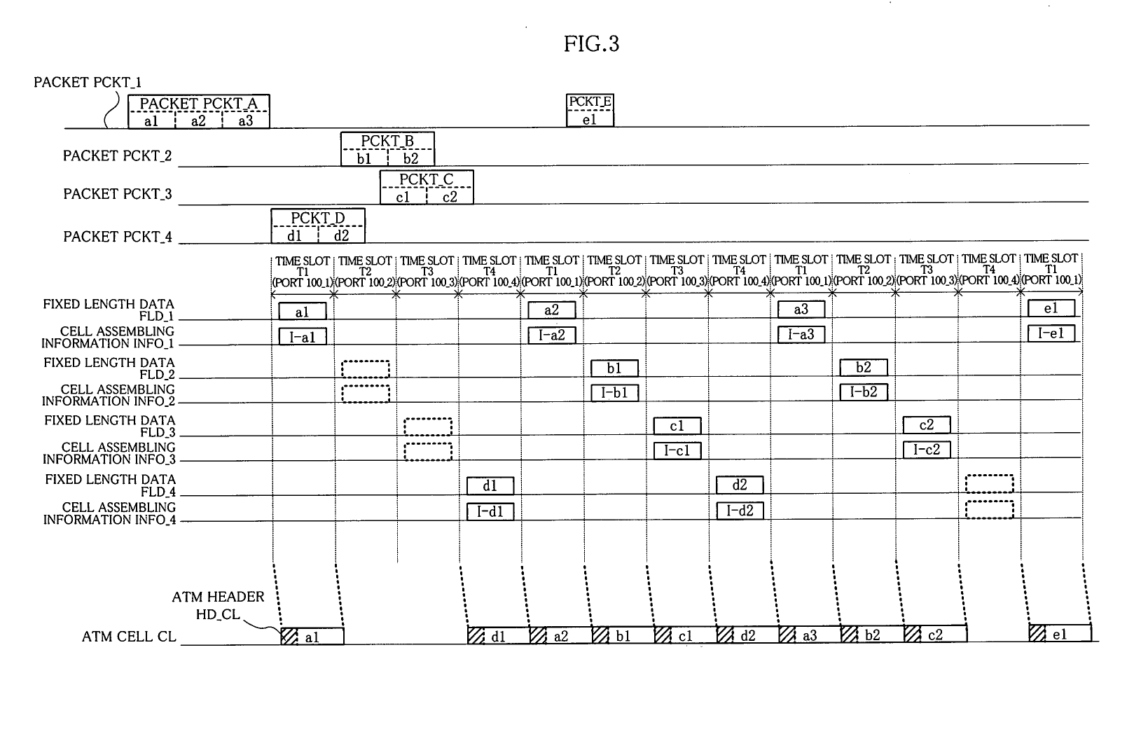

### [1]-2-1 Embodiment of Entire Operation: FIGS. 2 and 3

FIG. 3 shows an entire operation time chart of the cell assembling device of FIG. 2.

It is supposed that the packets PCKT_1-PCKT_4 from the ports 100_1-100_4 shown in FIG. 2 are respectively received in an order shown in FIG. 3 (packet PCKT_A (port 100_1)PCKT_D (100_4)→PCKT_B (100_2)→PCKT_C (100_3)→PCKT_E (100_1)) and with a packet length (packet PCKT_A (fixed length data a1+a2+a3), PCKT_B (b1+b2), PCKT_C (c1+c2), PCKT_D (d1+d2), PCKT_E (e1)), and the packets PCKT_A-PCKT_E are respectively stored in the packet buffers 200_1-200_4.

In this state, the time slot manager 300 firstly provides a time slot signal T1 (hereinafter, represented by a reference character T) to e.g. the port 100_1, namely provides the read request RQ to the packet buffer 200_1 in order to read the data per fixed length data, thereby reading the first fixed length data a1 of the packet PCKT_A as the fixed length data FLD_1 to be provided to the cell assembling processor 400.

Also, in synchronization with this reading, the cell assembling information generator 500_1 generates cell assembling information I-a1 as the cell assembling information INFO_1 from the fixed length data a1 to be provided to the cell assembling processor 400.

The cell assembling processor 400 having received the fixed length data a1 and the cell assembling information I-a1 generates an ATM header HD_CL based on the cell assembling information I-a1, and capsulates and converts the ATM header HD_CL and the fixed length data a1 into the ATM cell CL, as will be described later.

Then, the time slot manager 300 reads the fixed length data FLD_2 by providing a time slot signal T2 to the port 100_2, i.e. the read request RQ per fixed length data to the packet buffer 200_2. However, as shown by the dotted lines in FIG. 3, the storage of the packet PCKT_B in the packet buffer 200_2 has not been completed at this timing. Therefore, nothing is read from the packet buffer 200_2. As a result, no conversion into the ATM cell CL is performed in the cell assembling processor 400 as a matter of course.

Thereafter, by using fixed length data a2-e1 read from cyclic time slot signals T3→T4→T1→ . . . provided by the time slot manager 300, and cell assembling information I-a2-I-e1 generated by the cell assembling information generators 500_1-500_4 in synchronization with the fixed length data a2-e1, the cell assembling processor 400 similarly converts the data into the ATM cell CL.

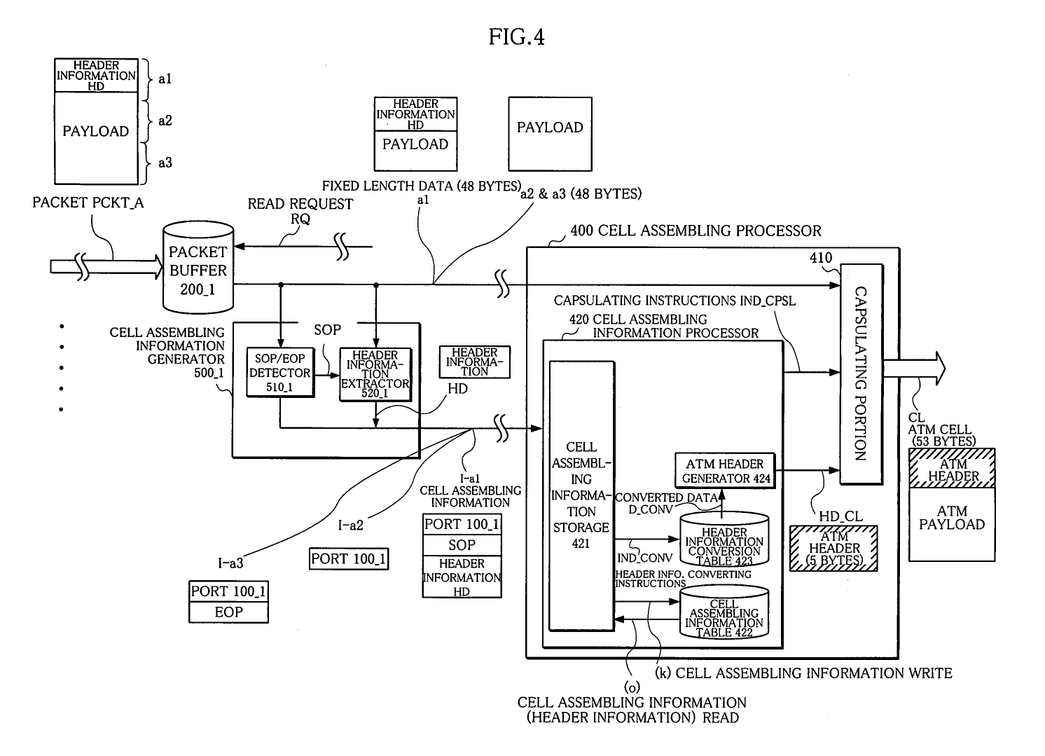

### [1]-2-2 Cell Assembling Example: FIGS. 4, 5A, 5B, and 5C

FIG. 4 shows a part of the arrangement related to the cell assembling of the packet PCKT_A shown in FIG. 3, extracted to be emphasized within the cell assembling device shown in FIG. 2 where the ports 100_1-100_4, the packet buffers 200_2-200_4, the time slot manager 300, and the cell assembling information generators 500_2-500_4 are omitted. The same applies to other embodiments described hereinbelow.

It is supposed that the packet PCKT_A is an Ethernet packet (variable length packet) of a total of 144 bytes composed of a total of 14 bytes of header information HD including a destination address (6 bytes), a source address (6 bytes), and a Type/Length (2 bytes), a payload (130 bytes in this example) equal to or more than 46 bytes, and an FCS (Frame Check Sequence)(omitted in this example) of 4 bytes as shown in e.g. FIG. 5A.

Firstly, by the read request RQ provided from the time slot manager 300, the first fixed length data a1 (48 bytes corresponding to the ATM payload length shown in FIG. 5C) of the packet PCKT_A is read from the packet buffer 200_1 to be provided to the capsulating portion 410 in the cell assembling processor 400.

In synchronization with reading the fixed length data a1, the SOP/EOP detector 510_1 in the cell assembling information generator 500_1 detects the SOP from e.g. a preamble or a bit pattern of SFD (Start Frame Delimiter) as shown by dotted lines of FIG. 5A, sets an identifier of the port 100_1 and the SOP in the cell assembling information I-a1, and notifies the SOP to the header information extractor 520_1.

Also, the SOP/EOP detector 510_1 starts to count the reading of the fixed length data from the value of the length within the header information HD shown in e.g. FIG. 5A. Namely, in this example, the total of three times of reading, which is obtained by dividing the packet length 144 bytes of the packet PCKT_A set in the “Length” by 48 bytes, which is the fixed length data unit, is counted, non SOP/EOP is detected at the second reading, and the EOP is detected by the third reading. The same applies to other embodiments described hereinbelow.

The header information extractor 520_1 to which the SOP is notified extracts the header information HD of the packet PCKT_A from the fixed length data a1, and multiplexes the header information HD further into the cell assembling information I-a1. Thus, the cell assembling information generator 500_1 provides the cell assembling information I-a1 in which the identifier of the port 100_1, the SOP, the header information HD of the packet PCKT_A are set, to the cell assembling information processor 420 in the cell assembling processor 400.

The cell assembling information processor 420 having received the cell assembling information I-a1 provides to the capsulating portion 410 capsulating instructions IND_CPSL so as to make the capsulating portion 410 wait for the ATM header HD_CL from the ATM header generator 424 as will be described later to capsulate the ATM header HD_CL.

Also, the cell assembling information storage 421 in the cell assembling information processor 420 provides to the header information conversion table 423 header information converting instructions IND_CONV (address designation or the like) so as to obtain converted data D_CONV for converting the header information HD included in the cell assembling information I-a1 into the ATM header.

Furthermore, the cell assembling information storage 421 writes (stores) the cell assembling information I-a1 in the cell assembling information table 422 in order to perform the subsequent cell assembling (see (k) in FIG. 4).

The ATM header generator 424 having received the converted data D_CONV from the header information conversion table 423 generates the ATM header HD_CL (5 bytes) based on the converted data D_CONV to be provided to the capsulating portion 410.

Thus, the capsulating portion 410 having been waiting for the ATM header HD_CL from the ATM header generator 424 capsulates the fixed length data a1 and the ATM header HD_CL to be converted into the ATM cell CL (53 bytes), and then transmits the ATM cell CL to an ATM network (not shown) at the subsequent stage.

By the read request RQ provided from the time slot manager 300, the intermediate fixed length data a2 (48 bytes) of the packet PCKT_A is read from the packet buffer 200_1 to be provided to the capsulating portion 410.

Since this case is the second reading of the fixed length data, and the SOP/EOP detector 510_1 does not detect either SOP or EOP, the SOP/EOP detector 510_1 sets only the identifier of the port 100_1 in the cell assembling information I-a2 to be provided to the cell assembling information processor 420.

The cell assembling information processor 420 having received the cell assembling information I-a2 provides to the capsulating portion 410 the capsulating instructions IND_CPSL so as to make the capsulating portion 410 wait for the ATM header HD_CL from the ATM header generator 424 to capsulate the ATM header HD_CL in the same way as the case of the above-mentioned fixed length data a1.

The cell assembling information storage 421 reads the header information HD in the cell assembling information I-a1 stored in the cell assembling information table 422 (see (o) in FIG. 4) and provides the header information converting instructions IND_CONV of the header information HD to the header information conversion table 423.

The ATM header generator 424 having received the converted data D_CONV from the header information conversion table 423 generates the ATM header HD_CL based on the converted data D_CONV in the same way as the above to be provided to the capsulating portion 410.

Thus, the capsulating portion 410 capsulates the fixed length data a2 and the ATM header HD_CL to be converted into the ATM cell CL, and then transmits the ATM cell CL to the ATM network at the subsequent stage.

Furthermore, when the fixed length data a3 (48 bytes) of the end of the packet PCKT_A is read in the same way as the cases of the above-mentioned fixed length data a1 and a2, the SOP/EOP detector 510_1 detects the EOP since the third reading is recognized, sets the identifier of the port 100_1 and the EOP in the cell assembling information I-a3 to be provided to the cell assembling processor 420.

Thus, the cell assembling processor 400 converts the fixed length data a3 into the ATM cell CL in the same way as the fixed length data a1 and a2 to be transmitted to the ATM network.

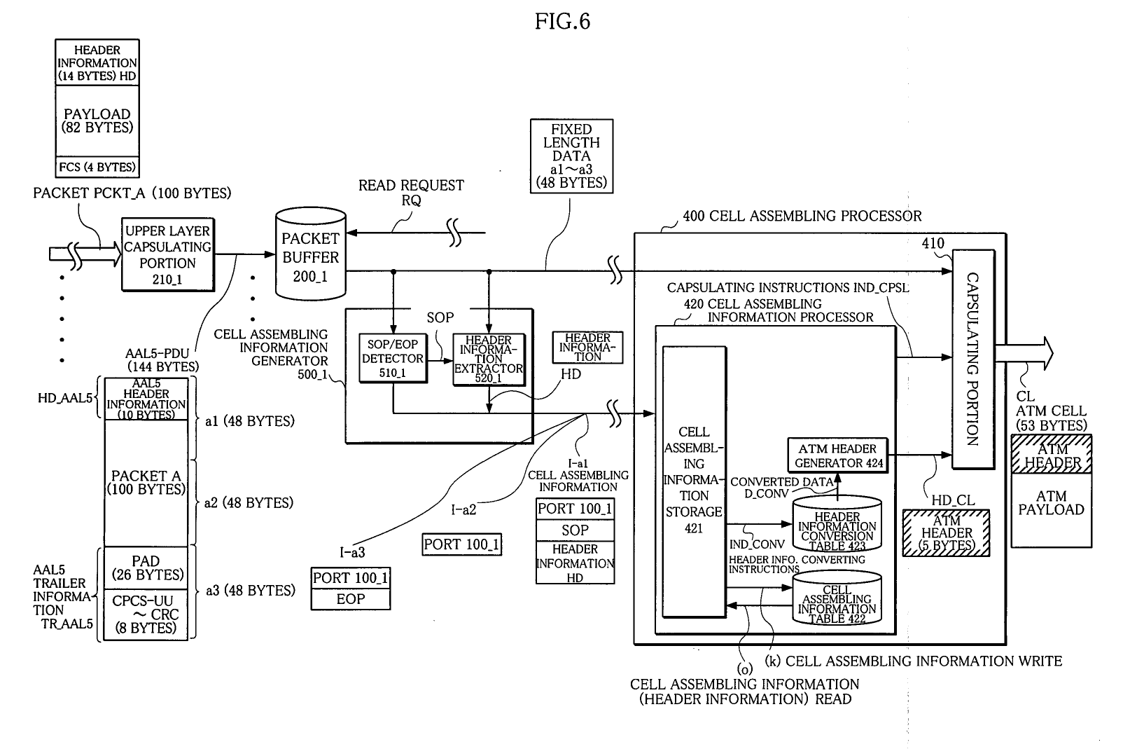

### Embodiment [2]: FIG. 6

### [2]-1 Arrangement: FIG. 6

FIG. 6 shows a part of the arrangement related to the cell assembling of the packet PCKT_A shown in FIG. 3, extracted to be emphasized in the same way as FIG. 4. The cell assembling device in FIG. 6 is provided with an upper layer capsulating portion 210_1 (hereinafter, occasionally represented by a reference numeral 210) storing in the packet buffer 200_1 the packet PCKT_1 received from the input port 100_1 capsulated in the format of the AAL5 as shown in e.g. FIG. 5B, in addition to the arrangement of the above-mentioned embodiment [1].

It is supposed that while not shown in FIG. 6, upper layer capsulating portions 210_2-210_4 respectively corresponding to the ports 100_2-100_4 are provided.

### [2]-2 Embodiment of Operation: FIG. 6

It is supposed that in this embodiment, the packet PCKT_A is an Ethernet packet of a total of 100 bytes composed of the header information HD (14 bytes), a payload (82 bytes), and 4 bytes of FCS, different from the example of FIG. 4.

The upper layer capsulating portion 210_1 to which the packet PCKT_A received from the port 100_1 is provided adds AAL5 header information HD_AAL5 (10 bytes) and AAL5 trailer information TR_AAL5 as shown in FIG. 5B, to generate an AAL5-PDU shown in FIG. 6 to be stored in the packet buffer 200_1. In this example, “0” of 26 bytes is set in the PAD (padding) within the AAL5 trailer information TR_AAL5 so that the entire length of the AAL5-PDU may become a common multiplier of the ATM payload length (48 bytes).

Thereafter, in the same way as the above-mentioned embodiment [1], the fixed length data a1-a3 (each data is 48 bytes) sequentially read every time the read request RQ is provided from the time slot manager 300, and the cell assembling information I-a1-I-a3 generated by the cell assembling generator 500_1 in synchronization with the fixed length data a1-a3 are provided to the cell assembling processor 400. The cell assembling portion 400 having received the fixed length data a1-a3 and the cell assembling information I-a1-I-a3 sequentially converts the fixed length data a1-a3 into the ATM cell CL to be transmitted to the ATM network.

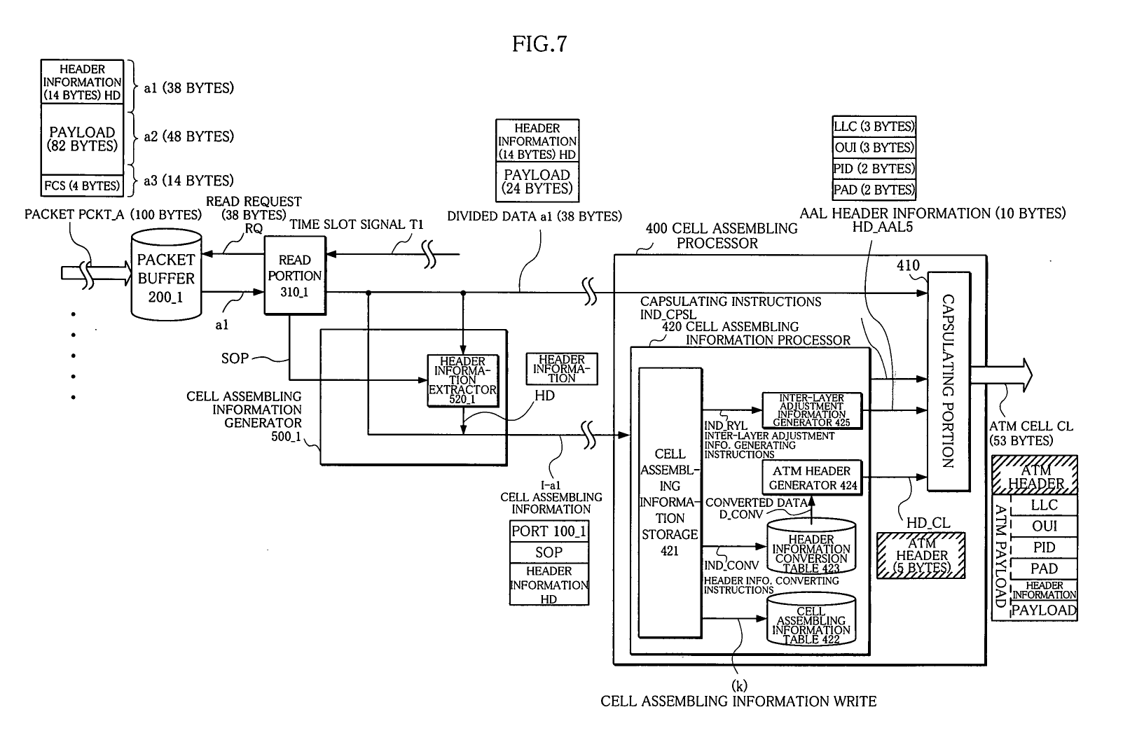

### Embodiment [3]: FIGS. 7-9

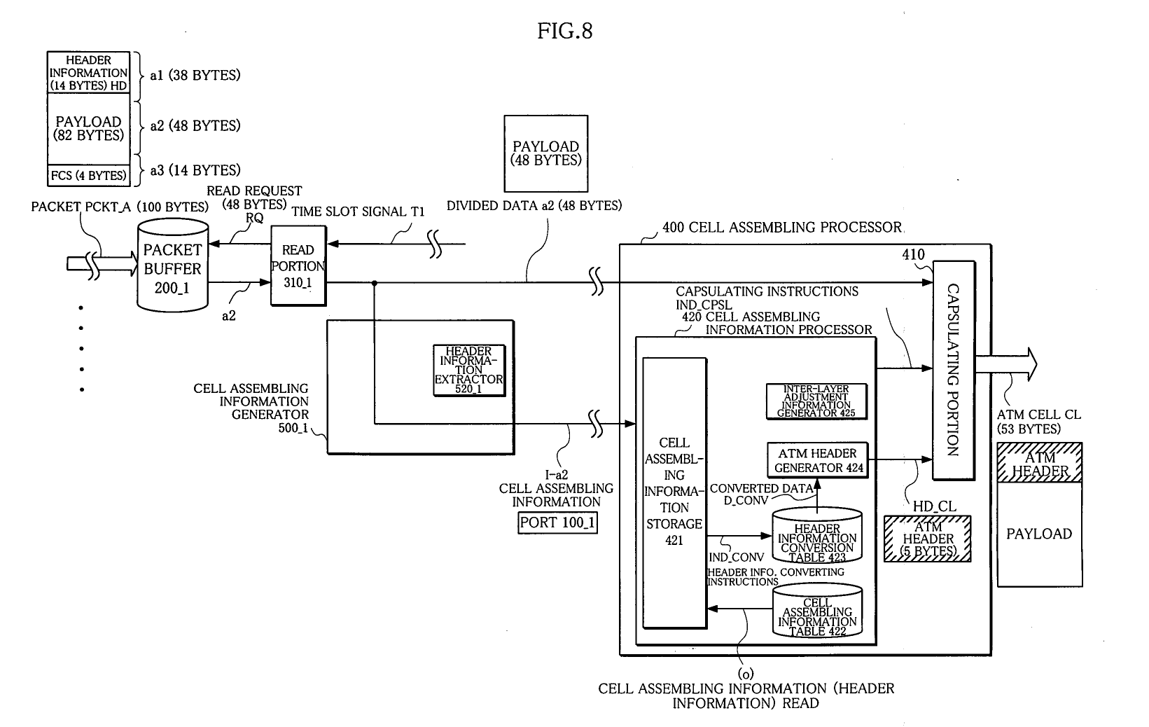

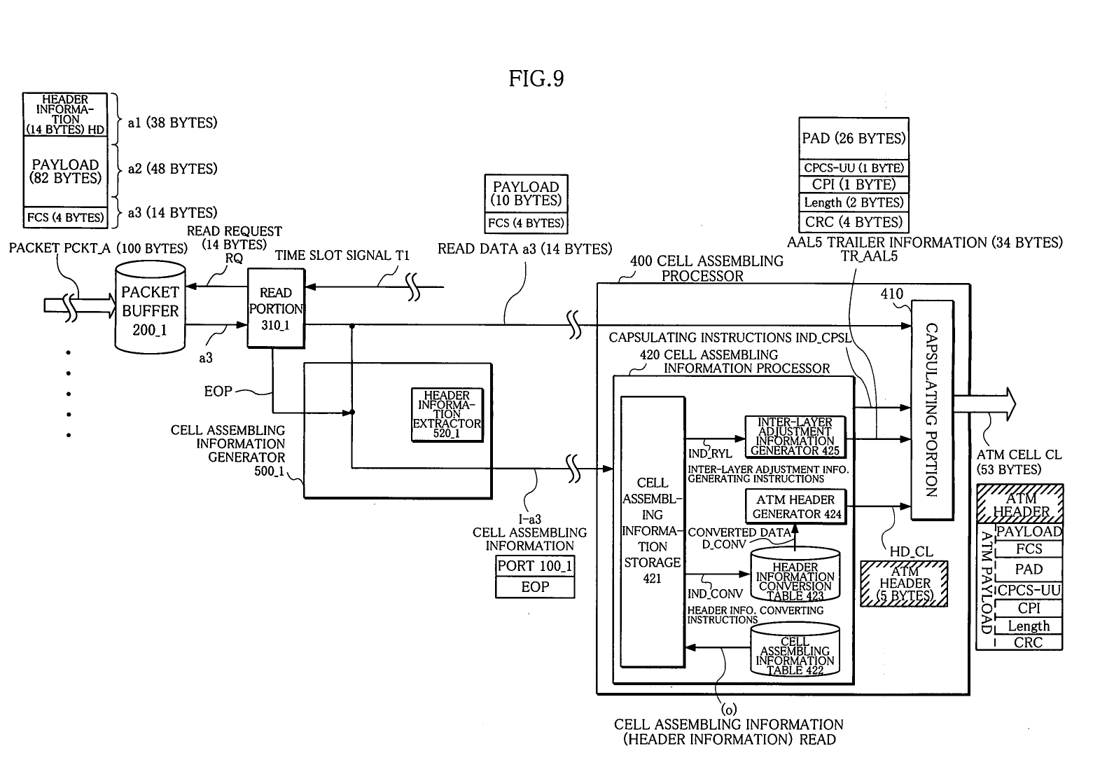

### [3]-1 Arrangement: FIG. 7 (Common to FIGS. 8 and 9)

FIG. 7 shows a part of the arrangement related to the cell assembling of the packet PCKT_A shown in FIG. 3, extracted to be emphasized in the same way as FIG. 4. The cell assembling device shown in FIG. 7 is provided with a read portion 310_1 (hereinafter, occasionally represented by a reference numeral 310) reading the packet PCKT_1 from the packet buffer 200_1 as divided data of a start, an end, and an intermediate portion with the time slot signal T1 provided from the time slot manager 300 as a read timing, and an inter-layer adjustment information generator 425, provided within the cell assembling information processor 420, generating inter-layer adjustment information such as the AAL5 header information HD_AAL5 and the AAL5 trailer information TR_AAL5 as shown in FIG. 5B, in addition to the arrangement shown in the above-mentioned embodiment [1].

Also, the SOP/EOP detector 510_1 as shown in the above-mentioned embodiments [1] and [2] is not provided in the cell assembling information generator 500_1, and the read portion 310_1 is provided with an SOP and an EOP detecting function (read count) of the SOP/EOP detector 510_1.

It is supposed that while not shown in FIG. 7, corresponding read portions 310_2-310_4 are provided for each of the packet buffers 200_2-200_4.

### [3]-2 Embodiment of Operation: FIGS. 7-9

Firstly, as for the operation of the embodiment [3], the sizes of the divided data read from the packet buffer 200 by the read portion 310_1 differ among the start (1)(38 bytes), the intermediate portion (2)(48 bytes), and the end (3)(14 bytes) of the packet PCKT as shown in FIG. 7. Corresponding to the sizes, the time slot signal T1 is provided from the time slot manager 300, and accordingly the operation within the cell assembling processor 400 differs. Therefore, the operation will now be described as divided into corresponding cell assembling examples (1)-(3).

### [3]-2-1 Cell Assembling Example (1)(Upon SOP Detection): FIG. 7

It is supposed that the packet PCKT_A shown in FIG. 7 is an Ethernet packet (total of 100 bytes) the same as that shown in the above-mentioned embodiment [2].

In this case, the read portion 310_1 provides the read request RQ to the packet buffer 200_1 with the time slot signal T1 provided from the time slot manager 300 as the read timing, reads the first divided data a1 (38 bytes) of the packet PCKT_A, and provides the divided data a1 to the capsulating portion 410. Also, concurrently with the reading of the divided data a1, the read portion 310_1 notifies the detected SOP to the header information extractor 520_1 within the cell assembling information generator 500_1.

It is to be noted that the reason why the read size of the divided data a1 is given 38 bytes, which is smaller than the ATM payload length 48 bytes, is to produce the ATM cell CL of the fixed length (53 bytes) by having the AAL5 header information HD_AAL5(10 bytes) added by the inter-layer adjustment information generator 425 as will be described later.

Also, the read portion 310_1 starts a count, with a counter not shown, of reading of the divided data from the length of the header information HD within the divided data a1 in order to detect the EOP described later, in the same way as the SOP/EOP detector 510_1 in the above-mentioned embodiments [1] and [2]. It is to be noted that in this example the total of three times of reading is counted as the packet length (100 bytes) of the packet PCKT_A set for “Length” is divided to give only the first divided data a1 38 bytes, and the remainder is divided by the payload length (48 bytes) of the ATM cell as a general rule, where a length less than 48 bytes is regarded as one reading.

The header information extractor 520_1 to which the SOP is notified extracts the header information HD of the packet PCKT_A from the divided data a1, in the same way as the above-mentioned embodiments [1] and [2], and multiplexes the header information HD into the cell assembling information I-a1. Thus, the cell assembling information generator 500_1 provides to the cell assembling information processor 420 the cell assembling information I-a1 in which the identifier of the port 100_1, the SOP, and the header information HD of the packet PCKT_A are set.

The cell assembling information processor 420 having received the cell assembling information I-a1 recognizes that the SOP is included in the cell assembling information I-a1, namely, that the AAL5 header information HD_AAL5 is required to be generated as the inter-layer adjustment information, and provides to the capsulating portion 410 the capsulating instructions IND_CPSL so as to make the capsulating portion 410 wait for the ATM header HD_CL from the ATM header generator 424 as will be described later to capsulate the AAL5 header information HD_AAL5 from the inter-layer adjusting information generator 425.

Also, the cell assembling information storage 421 provides the header information converting instructions IND_CONV to the header information conversion table 423, and further writes (stores) the cell assembling information I-a1 in the cell assembling information table 422 so as to make the header information conversion table 423 perform the subsequent cell assembling (see (k) in FIG. 7), in the same way as the above-mentioned embodiments [1] and [2].

The ATM header generator 424 having received the converted data D_CONV from the header information conversion table 423 generates the ATM header HD_CL based on the converted data D_CONV to provide the ATM header HD_CL to the capsulating portion 410.

Also, concurrently with the generation of the above-mentioned ATM header HD_CL, the cell assembling information storage 421 provides to the inter-layer adjustment information generator 425 the inter-layer adjustment information generating instructions IND_RYL so as to make the inter-layer adjustment information generator 425 generate a total of 10 bytes of the AAL5 header information HD_AAL5 including 3 bytes of LLC (Logical Link Control), 3 bytes of OUI (Organizationally Unique Identifier), 2 bytes of PID (Protocol Identifier), and 2 bytes of PAD shown in FIG. 5B.

The inter-layer adjustment information generator 425 having received this actually generates the AAL5 header information HD_AAL5 to be provided to the capsulating portion 410.

Thus, the capsulating portion 410 having been waiting for the ATM header HD_CL from the ATM header generator 424 and the AAL5 header information HD_AAL5 from the inter-layer adjustment information generator 425 capsulates the divided data a1 (38 bytes), the ATM header HD_CL (5 bytes), and the AAL5 header information HD_AAL5 (10 bytes) to be converted into the ATM cell CL (53 bytes), and then transmits the ATM cell CL to the ATM network at the subsequent stage.

### [3]-2-2 Cell Assembling Example (2)(Upon SOP/EOP Non-detection): FIG. 8

FIG. 8 shows a cell assembling example for the divided data a2 (48 bytes), i.e. the data which is neither the SOP nor the EOP, in the packet PCKT_A shown in the above-mentioned cell assembling example (1).

In this case, the read portion 310_1 provides the read request RQ to the packet buffer 200_1 with the time slot signal T1 provided from the time slot manager 300 as the read timing, reads the divided data a2 (48 bytes), and provides the divided data a2 to the capsulating portion 410. Also, the read portion 310_1 detects neither the SOP nor the EOP, since this is the second reading of the divided data.

Therefore, the cell assembling information generator 500_1 sets only the identifier of the port 100_1 in the cell assembling information I-a2 to be provided to the cell assembling information processor 420.

The cell assembling information processor 420 having received the cell assembling information I-a2 recognizes that the cell assembling information I-a2 includes neither the SOP nor the EOP, namely that the generation of the layer adjustment information is not required, and provides to the capsulating portion 410 the capsulating instructions IND_CPSL so as to make the capsulating portion 410 wait for only the ATM header HD_CL from the ATM header generator 424 to capsulate the ATM header HD_CL.

The cell assembling information storage 421, in the same way as the above-mentioned embodiments [1] and [2], reads the header information HD in the cell assembling information I-a1 stored in the cell assembling information table 422 (see (o) in FIG. 8), and provides the header information converting instructions IND_CONV of the header information HD to the header information conversion table 423.

The ATM header generator 424 having received the converted data D_CONV from the header information conversion table 423 generates the ATM header HD_CL based on the converted data D_CONV to be provided to the capsulating portion 410.

Thus, the capsulating portion 410 having been waiting for only the ATM header HD_CL from the ATM header generator 424 capsulates only the divided data a2 and the ATM header HD_CL to be converted into the ATM cell CL, and then transmits the ATM cell CL to the ATM network at the subsequent stage.

### [3]-2-3 Cell Assembling Example (3)(Upon EOP Detection): FIG. 9

FIG. 9 shows a cell assembling example for the divided data a3 (14 bytes) within the packet PCKT_A shown in the above-mentioned cell assembling examples (1) and (2), namely the data corresponding to the EOP.

In this case, the read portion 310_1 provides the read request RQ to the packet buffer 200_1 with the time slot signal T1 provided from the time slot manager 300 as the read timing, reads the divided data a3 (14 bytes), and provides the divided data a3 to the capsulating portion 410. Also, the read portion 310_1 detects the EOP to be notified to the cell assembling information generator 500_1 since the third reading is recognized.

The cell assembling information generator 500_1 to which the EOP is notified sets the identifier of the port 100_1 and the EOP in the cell assembling information I-a3 to be provided to the cell assembling information processor 420.

The cell assembling information processor 420 having received the cell assembling information I-a3 recognizes that the cell assembling information I-a3 includes the EOP, namely that the generation of the AAL5 trailer information TR_AAL5 as the layer adjustment information is required, and provides to the capsulating portion 410 the capsulating instructions IND_CPSL so as to make the capsulating portion 410 wait for the ATM header HD_CL from the ATM header generator 424 and the AAL5 trailer information TR_AAL5 from the inter-layer adjustment generator 425 to capsulate the ATM header HD_CL and the AAL5 trailer information TR_AAL5. It is to be noted that the cell assembling information I-a3 is not stored in the cell assembling information table 422 upon EOP detection.

The cell assembling information storage 421, in the same way as the above-mentioned embodiment [2], reads the header information HD in the cell assembling information I-a1 stored in the cell assembling information table 422 (see (o) in FIG. 9), and provides the header information converting instructions IND_CONV of the header information HD to the header information conversion table 423.

The ATM header generator 424 having received the converted data D_CONV from the header information conversion table 423 generates the ATM header HD_CL based on the converted data D_CONV to be provided to the capsulating portion 410.

Also, concurrently with the generation of the above-mentioned ATM header HD_CL, the cell assembling information storage 421 provides to the inter-layer adjustment information generator 425 the inter-layer adjustment information generating instructions IND_RYL so as to make the inter-layer adjustment information generator 425 generate a total of 34 bytes of the AAL5 trailer information TR_AAL5 including a PAD in which e.g. “0” of 26 bytes is set, 1 byte of CPCS-UULLC (displayed between users), 1 byte of CPI (Common Part Indicator), 2 bytes of Length, and 4 bytes of CRC (Cyclic Redundancy checking) shown in FIG. 5B.

The inter-layer adjustment information generator 425 having received the inter-layer adjustment information generating instructions IND_RYL actually generates the AAL5 trailer information TR_AAL5 to be provided to the capsulating portion 410.

Thus, the capsulating portion 410 having been waiting for the ATM header HD_CL from the ATM header generator 424 and the AAL5 trailer information TR_AAL5 from the inter-layer adjustment information generator 425 capsulates the divided data a3 (14 bytes) and the ATM header HD_CL (5 bytes) and the AAL5 trailer information TR_AAL5 (34 bytes) to be converted into the ATM cell CL (53 bytes), and then transmits the ATM cell CL to the ATM network at the subsequent stage.

It is to be noted that the present invention is not limited to the above-mentioned embodiments and it is obvious that various modifications may be made by one skilled in the art based on the recitation of the claims.

What is claimed is:

1. A cell assembling method comprising:
a first step of storing packets received from a plurality of input ports in buffers provided corresponding to the input ports;
a second step of reading the packets per fixed length data from the buffers by sequentially providing a read request to the buffers; and
a third step of converting the fixed length data into cells.

2. The cell assembling method as claimed in claim 1, wherein the second step comprises a step of sequentially and cyclically reading the packets per fixed length data from the buffers with sequentially and cyclically providing the read request to the buffers at regular intervals.

3. The cell assembling method as claimed in claim 1, wherein the first step comprises a step of capsulating the received packets to an upper layer and of storing the capsulated packets in the buffers.

4. The cell assembling method as claimed in claim 1, further comprising a fourth step of generating cell assembling information necessary for converting the fixed length data read at the second step into the cells, and a fifth step of generating header information of the cells based on the cell assembling information and of using the header information for the conversion at the third step.

5. The cell assembling method as claimed in claim 4, wherein the cell assembling information includes an identifier of the input ports, header information of the received packets, and an identifier indicating fixed length data of a start or an end of the received packets.

6. The cell assembling method as claimed in claim 5, wherein only when detecting the fixed length data of the start of the received packets, the fourth step comprises a step of setting the header information of the received packets in the cell assembling information.

7. A cell assembling method comprising:
a first step of storing packets received from a plurality of input ports in buffers provided corresponding to the input ports;
a second step of dividing the packets from the buffers into data of a start, an end, and an intermediate portion to be sequentially read; and
a third step of adding to the divided data inter-layer adjustment information necessary for capsulation to an upper layer, corresponding to a size of the divided data read at the second step and of converting the divided data into cells.

8. The cell assembling method as claimed in claim 7, wherein the second step comprises a step of dividing the packets from the buffers into the data of the start, the end, and the intermediate portion to be sequentially and cyclically read.

9. The cell assembling method as claimed in claim 7, further comprising a fourth step of generating cell assembling information necessary for converting the divided data read at the second step into the cells, and a fifth step of generating header information of the cells based on the cell assembling information and of using the header information for the conversion at the third step.

10. The cell assembling method as claimed in claim 9, wherein the cell assembling information includes an identifier of the input ports, header information of the received packets, and an identifier indicating the divided data of the start or the end of the received packets.

11. The cell assembling method as claimed in claim 10, wherein only when detecting the divided data of the start of the received packets, the fourth step comprises a step of setting the header information of the received packets in the cell assembling information.

12. The cell assembling method as claimed in claim 4, wherein the fifth step comprises a step of storing the cell assembling information to be used for conversions to subsequent cells.

13. A cell assembling device comprising:
a first means storing packets received from a plurality of input ports in buffers provided corresponding to the input ports;
a second means reading the packets per fixed length data from the buffers by sequentially providing a read request to the buffers; and
a third means converting the fixed length data into cells.

14. The cell assembling device as claimed in claim 13, wherein the second means comprises a means sequentially and cyclically reading the packets per fixed length data from the buffers with sequentially and cyclically providing the read request to the buffers at regular intervals.

15. The cell assembling device as claimed in claim 13, wherein the first means comprises a means capsulating the received packets to an upper layer and storing the capsulated packets in the buffers.

16. The cell assembling device as claimed in claim 13, further comprising a fourth means generating cell assembling information necessary for converting the fixed length data read by the second means into the cells, and a fifth means generating header information of the cells based on the cell assembling information and using the header information for the conversion by the third means.

17. The cell assembling device as claimed in claim 16, wherein the cell assembling information includes an identifier of the input ports, header information of the received packets, and an identifier indicating fixed length data of a start or an end of the received packets.

18. The cell assembling device as claimed in claim 17, wherein only when detecting the fixed length data of the start of the received packets, the fourth means comprises a means setting the header information of the received packets in the cell assembling information.

19. The cell assembling device as claimed in claim 16, wherein the fifth means comprises a means storing the cell assembling information to be used for conversions to subsequent cells.
